(19) United States
(12) Patent Application Publication
(10) Pub. No.: US 2005/0104366 A1
(43) Pub. Date: May 19, 2005

(54) Method and apparatus for associating identifiers with can-top advertisements

(76) Inventor: Kenneth McClintock, Dallas, TX (US)

Correspondence Address: BAKER & MCKENZIE;PATENT DEPARTMENT, 2001 ROSS AVENUE, SUITE 2300, DALLAS, TX, 75201, US

(21) Appl. No.: 10/317,259

(22) Filed: Dec. 11, 2002

Related U.S. Application Data
(60) Provisional application No. 60/429,031, filed on Nov. 22, 2002.
(60) Provisional application No. 60/431,864, filed on Dec. 6, 2002.

(51) Int. Cl. B42D 15/00; B32B 3/00

(52) U.S. Cl. 283/81

(57) ABSTRACT

The present invention is a label designed to be placed on the top of a can. On this label is the web address of a web site. This address can be unique to the can-top advertisement, or it can be the address of a general web site. If the address is that of a general web site, an identifier that is unique to the can-top advertisement is also included on the label. In the case of a unique web address, when a person visits the web site located at the web address, a record is made of the person's visit. Since the web address is unique to the can-top advertisement, all parties concerned with the advertisement can be assured that the person was directed to the web site by the can-top advertisement. If the web address is to a company's general web site, the web site will prompt the person to enter the unique identifier on the can-top advertisement. Again, once the unique identifier is entered, it will be clear to all concerned that the person was directed to the web site by the can-top advertisement.

### REFERENCE TO EARLIER FILED APPLICATION

This application claims the benefit of U.S. Provisional Application No. 60/429031, filed Nov. 22, 2002, and [Pending], filed Dec. 6, 2002.

### BACKGROUND OF THE INVENTION

1. Technical Field

The present invention relates generally to can-top advertisements. More specifically, the present invention uses can-top advertisements to promote web sites, and uses certain information to conclusively demonstrate that the visitor to a particular web site was directed there by the can-top advertisement.

2. Description of the Related Art

According to some accounts, the can-top advertising market is poised for explosive growth. Some of these can-top advertisements are directed to driving consumers to Internet web-sites. Using traditional advertisements, however, makes it difficult to determine whether a particular can-top advertisement was responsible for directing a particular person to a web site. This problem makes it difficult for advertisers to determine the value of can-top advertisements. Thus, it would be desirable to have a can-top advertisement that directs persons to a web site, while, at the same time, conclusively demonstrates that it was the can-top advertisement (and not some other advertisement) that was responsible for directing the person to the web site.

### SUMMARY OF THE INVENTION

The present invention is a label designed to be placed on the top of a can. On this label is the web address of a web site. This address can be unique to the can-top advertisement, or it can be the address of a general web site. If the address is that of a general web site, an identifier that is unique to the can-top advertisement is also included on the label. In the case of a unique web address, when a person visits the web site located at the web address, a record is made of the person's visit. Since the web address is unique to the can-top advertisement, all parties concerned with the advertisement can be assured that the person was directed to the web site by the can-top advertisement. If the web address is to a company's general web site, the web site will prompt the person to enter the unique identifier on the can-top advertisement. Again, once the unique identifier is entered, it will be clear to all concerned that the person was directed to the web site by the can-top advertisement.

### BRIEF DESCRIPTION OF THE DRAWINGS

The novel features which are believed to be characteristic of the present invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a label bearing a can-top advertisement;

FIG. 2 shows a computer network upon which the present invention can be implemented;

FIG. 3 is a flowchart showing one method of operation according to the present invention;

FIG. 4 is another label having a can-top advertisement; and

FIG. 5 is yet another label having a can-top advertisement.

### DETAILED DESCRIPTION OF THE INVENTION

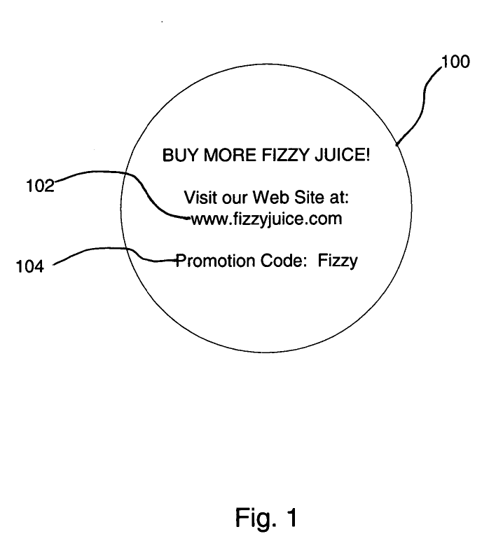

In general, the present invention describes a method and apparatus by which companies can track the effectiveness of a particular form of advertising. The term “can-top advertising” is used herein to refer to advertisements and other promotions that are printed on a label that is designed to fit over the top portion of a can, such as a beverage can. One example of such a label is shown in FIG. 1. More details concerning the composition and creation of such labels can be found in U.S. patent application Ser. No. 09/951,723 (U.S. Pub. No. 2002/0062922), which is hereby incorporated by reference.

Companies often do not know for certain how effective their advertising campaigns are. The same holds true for can-top advertising. In order to assist a company in determining the effectiveness of their can-top advertising campaign, certain information can be placed on the can-top advertisement to give the company feedback on the particular ad campaign.

In one embodiment, this information consists of a web address and an identifier. An example of such information is presented on the label shown in FIG. 1. Label 100 contains web address 102, which is the web site for Fizzy Juice, Inc. (a fictitious company). Along with web address 102 is identifier 104 in the form of a “promotion code.” This code is designed to be entered by the user when the user visits Fizzy Juice, Inc.'s web site.

When the Fizzy Juice consumer visits the web site specified on the can-top advertisement, the consumer is prompted for the promotion code. Once the consumer inputs the code, it is stored for subsequent processing by Fizzy Juice, Inc. Such processing allows for the company to make some potentially valuable conclusions about the nature of its consumers and the appeal of its product's packaging, as well as the can-top advertisement itself. Fizzy Juice, Inc. can make such conclusions by comparing the number of times the particular code is entered on the fizzyjuice.com web site to the number of cans that were sold with the can-top advertisement having the particular promotion code.

The same code can be placed on all of the Fizzy Juice can-top advertisements, or, it can be varied according to geographic market, the particular advertisement featured on a Fizzy Juice can-top advertisement, the date a particular can was manufactured, or any one of a number of factors. Varying the code allows Fizzy Juice, Inc. to determine, on a relative basis, the customer appeal of its product. For example, assume a million cans of Fizzy Juice are sent to both Texas and Florida with can-top advertisements having two different promotion codes. If twice as many Texans log-on to the fizzyjuice.com web site and enter the Texas promotion code (compared to Florida citizens entering the Florida promotion code), Fizzy Juice, Inc. can draw certain conclusions from this discrepancy.

In another example, Fizzy Juice, Inc. may ship two sets of cans to one geographic area, with the first set having a professional athlete and a first promotion code on a can-top advertisement, while the second set features a rock star with a second promotion code. Differences between the number of first promotion codes received versus the second will undoubtedly be important in determining the effectiveness of the two different can-top advertisements.

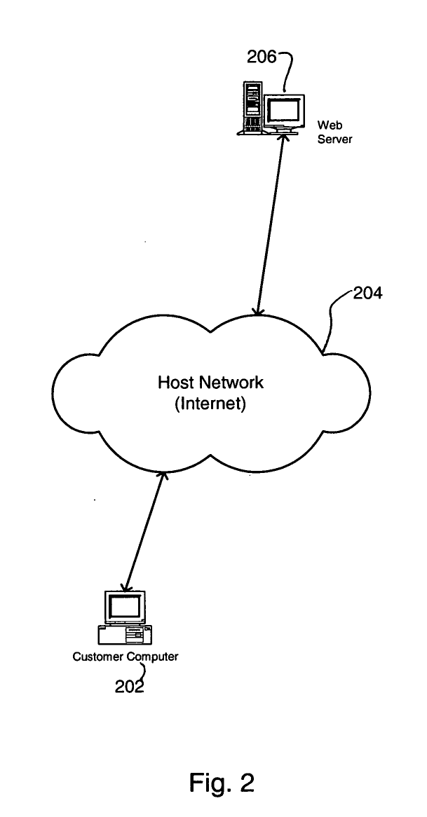

FIG. 2 shows a computer network on which the present invention can be implemented. Customer computer 202 is connected to network 204. An example of network 204 is the network of computer known as the Internet. Also attached to network 204 is web server 206. In the example presented above, web server 206 is the computer that hosts the web site located at www.fizzyjuice.com.

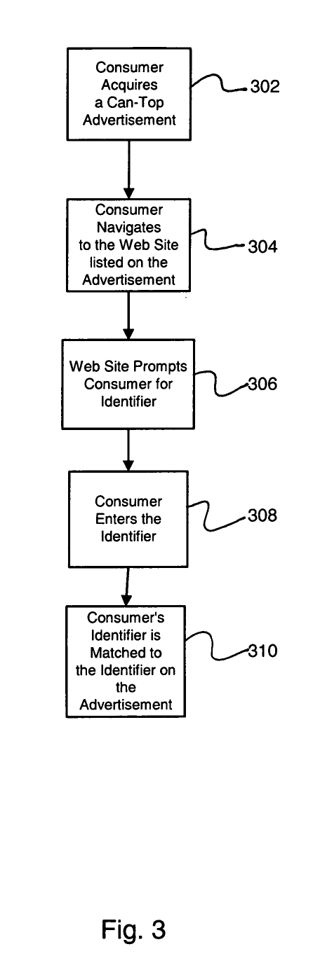

FIG. 3 is a flowchart that shows a method according to the present invention. Initially, a consumer acquires a can having a can-top advertisement (302). This can-top advertisement, like can-top advertisement 100, contains the address of a web site and an identifier. Next, the consumer enters the web address into a browser program operating on a personal computer or other device capable of accessing the Internet (e.g., a mobile phone, a PDA, etc.) (304). Once the consumer has successfully navigated to the web site located on the can-top advertisement, the web site prompts the user to enter the identifier also located on the can-top advertisement (306). Upon being prompted, the consumer enters the identifier (308). The identifier entered by the consumer is then matched to the identifier on the can-top advertisement (310). Once this match has occurred, a determination can be made that the consumer navigated to the web site due to the can-top advertisement.

While the examples listed above contemplate a company conducting its own advertising campaign, there are other examples of how the present invention can be used. For instance, instead of Fizzy Juice, Inc. conducting its own advertising campaign, it could contract with a third-party to create the can-top advertisements. Using the present invention, the fee paid to this third-party could be based on the number of times someone accesses the fizzyjuice.com web site and enters the promotion code associated with advertisements produced and created by the third-party. In this manner, the present invention can be used to pay third-party advertisers based on the performance of their advertisements.

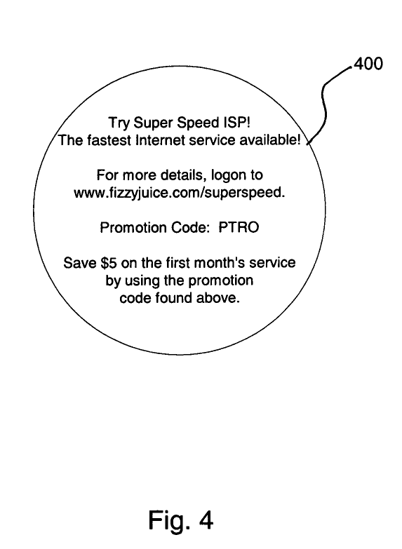

Another use of the present invention involves using the label shown in FIG. 1 to advertise third-party products and services. An example of such a label is shown in FIG. 4. In this example, label 400 is still being placed on cans of Fizzy Juice, but, unlike the example shown in FIG. 1, the advertisement is for an Internet service provider named “Super Speed ISP.” When this type of label is used, Fizzy Juice customers interested in Super Speed ISP log on to the fizzyjuice.com/superspeed web site and enter the promotion code. At this point, Super Speed ISP may pay a fee to Fizzy Juice, Inc. for the customers that Fizzy Juice, Inc. has directed to Super Speed ISP. Further, Fizzy Juice, Inc. will be able to prove that the customers it directed to Super Speed ISP came from the can-top advertisement by demonstrating how many promotion codes it received. To increase the customer's desire to access the Super Speed ISP site through Fizzy Juice's site (as opposed to accessing the Super Speed ISP site directly), rebates or discounts can be tied to the use of the promotion code (e.g., “Save $5 of your first month's service by using the promotion code found above!”).

A variation on the method described in relation to FIG. 4 involves a third-party advertising company, unrelated to Fizzy Juice, Inc. or Super Speed ISP. In this example, a third-party advertising company, Adverco, buys the right from Fizzy Juice to sell the space on the can-top advertisement to other third-parties, such as Super Speed ISP. In this example, Adverco first pays Fizzy Juice for the right to resell the space on the can-top advertisement. Then, Adverco goes out and markets the advertising space on the can-top advertisement to the highest bidder (or bidders). In this example, the web address on the can-top advertisement can be either a special web site operated by Adverco (i.e., adverco.com/superspeed) or it can be the web address of the company that is being advertised (i.e., superspeedisp.net). As described above, accompanying the web address will be a promotion code that must be entered on whatever web site is displayed. This code allows the company that is paying for the advertisement to determine the effectiveness of the can-top advertising. In one embodiment, Super Speed ISP pays Adverco for each unique visitor to its web site that inputs the promotion code found on the can-top advertisement created by Adverco.

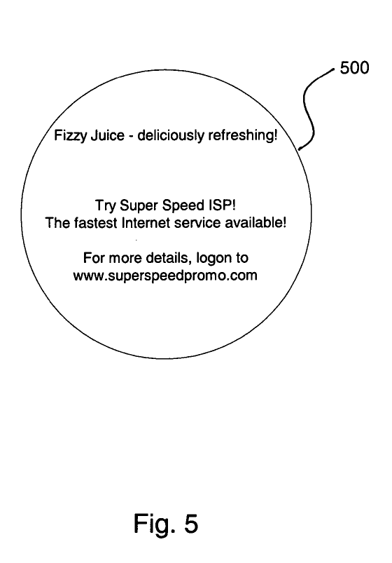

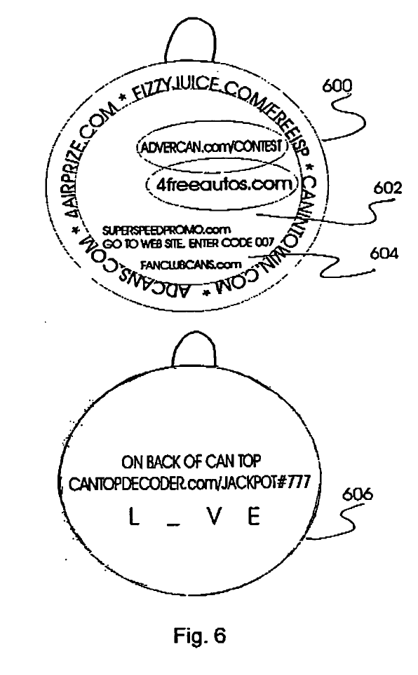

Another embodiment of the present invention is shown in FIG. 5. In this embodiment, two advertisements appear: one for Fizzy Juice and one for Super Speed ISP. The advertisement for Fizzy Juice is a standard advertisement without any reference to the Internet. On the other hand, the advertisement for Super Speed ISP contains a reference to a specific web address. This web address is unique to this particular can-top advertisement. Using a unique web address eliminates the need to have both a web address and a unique identifier, as anyone who navigates to the web address can be assumed to have received the web address from the particular can-top advertisement, since the web address is unique to the advertisement. As described above, knowing with certainty that an individual was directed to a particular web site is often an important consideration in the business arrangement between the company whose product/service is being advertised and the entity who created the advertisement.

Advertisement 500 also shows one of the business arrangements that is possible between the advertising entities (Fizzy Juice and Super Speed ISP) and an advertiser. The advertiser, which, for the purposes of this example will be assumed to be Adverco, can sell a portion of the can-top advertisement to Fizzy Juice at a fixed rate for every can that contains can-top advertisement 500. Then, it can agree with Super Speed ISP to place an advertisement for it, along with that of Fizzy Juice, on the same can top. Super Speed ISP and Adverco can further agree that Super Speed ISP is to pay Adverco a sum for every unique visitor to the web address superspeedpromo.com. Typically, the sum paid by Super Speed ISP for the visitors to its web site will be orders of magnitude higher than the fixed rate paid by Fizzy Juice for a single can-top advertisement. In this manner, Adverco can cover the cost of printing and attaching the can-top advertisement by contracting with Fizzy Juice, while, at the same time, receive additional money from Super Speed ISP for every person that visits the superspeedpromo.com web site.

Any number of advertising entities and their web sites can appear on a given can-top advertisement, as the specific numbers of entities on a particular can-top advertisement is not material to the present invention. Further, none of the entities on a can-top advertisement have to be related to the company or product on which the advertisement is being placed. For example, advertisement 500 could appear on top of a can of tuna fish.

Although advertisements for a beverage and an internet service provider were presented in the examples discussed above, advertisements using the present invention can be created for any number of other entities and products. Some examples of such entities and products are sports clubs, fashion designers, retail stores, nature clubs, industrial associations, periodicals, service providers, retail advertisers, health care notices, special events public elections, religious organizations, and governmental interests.

While the invention has been particularly shown and described with reference to a preferred embodiment, it will be understood by those skilled in the art that various changes in form and detail may be made therein without departing from the spirit and scope of the invention.

1. A system for tracking advertising on products, the system comprising:
a plurality of labels each to be placed on a corresponding product, the labels comprising:
an advertisement for an entity displayed on each label, each label shaped for placement on top of a can;
an Internet address associated with the entity and displayed on each label; and
a unique identifier associated with the advertisement, wherein the same unique identifier is displayed on each label; and
a computer server configured to host an Internet site associated with the Internet address, and configured to receive the unique identifier across a computer network from the user whereby the computer server determines the labels to have been referenced by the user to reach the Internet site.

2. (canceled)

3. A system for tracking advertising on products, the system comprising:
a plurality of labels each to be placed on a corresponding product, the labels comprising:
an advertisement for an entity displayed on each label, each label shaped for placement on top of a can;
a unique internet address for an Internet site associated with the entity, the same unique Internet address displayed on each label; and
a computer server configured to host an Internet site, and configured to determine the labels to have been referenced by the user to reach the Internet site when the user navigates to the Internet site using the unique Internet address.

4. (canceled)

5. A system according to claim 1, wherein the Internet address and unique identifier are located on unexposed faces of the labels when the labels are positioned on the tops of cans.

6. A system according to claim 1, wherein the unique identifier is located on corresponding faces of the labels opposite the Internet address.

7. A system according to claim 6, wherein the unique identifier is located on corresponding unexposed faces of the labels when the labels are positioned on the tops of cans.

8. A system according to claim 1, wherein the computer server is further configured to determine to someone other than the user the labels to have been referenced by the user to reach the Internet site.

9. A system according to claim 8, wherein the user is unaware of the determination by the computer server.

10. A system according to claim 1, wherein the unique identifier qualifies the user for a promotional contest when received by the computer server.

11. A system according to claim 1, wherein the computer server is further configured to determine a geographic location of the user's label based on receiving the unique identifier from the user.

12. A system according to claim 3, wherein the unique internet address and advertisement are located on corresponding unexposed faces of the labels when the labels are positioned on the tops of cans.

13. A system according to claim 3, wherein the unique internet address is located on corresponding faces of the labels opposite the advertisement.

14. A system according to claim 13, wherein the unique Internet address is located on corresponding unexposed faces of the labels when the labels are positioned on the tops of cans.

15. A system according to claim 3, wherein the computer server is further configured to determine to someone other than the user the labels to have been referenced by the user to reach the Internet site.

16. A system according to claim 15, wherein the user is unaware of the determination by the computer server.

17. A system according to claim 3, wherein the unique Internet address qualifies the user for a promotional contest when the user navigates to the Internet site using the unique Internet address.

18. A system according to claim 3, wherein the computer server is further configured to determine a geographic location of the user's label when the user navigates to the Internet site using the unique Internet address.

19. (canceled)

20. (canceled)

21. A label for providing a cover for a food or beverage container, the label comprising:
indicia of an Internet address; and
indicia of a unique identifier;
wherein a user removes the cover in order to access a surface of the food or beverage container, wherein a user further removes or alters at least a portion of the surface in order to access the contents of the container and wherein the label completely covers the surface; and
wherein the Internet address is specially configured for user input of the unique identifier.
